(19) United States
(12) Patent Application Publication
(10) Pub. No.: US 2026/0087096 A1
(43) Pub. Date: Mar. 26, 2026

(54) METHODS FOR ENROLLMENT OF PERSONALIZED LIQUID CONSUMPTION RATE

(71) Applicant: Apple Inc., Cupertino, CA (US)

(72) Inventor: Ioana Negoita, Sunnyvale, CA (US)

(21) Appl. No.: 19/311,445

(22) Filed: Aug. 27, 2025

Related U.S. Application Data
(60) Provisional application No. 63/698,689, filed on Sep. 25, 2024.

(51) Int. Cl. G06F 17/40; G06F 1/16; G06N 20/00

(52) U.S. Cl. CPC G06F 17/40; G06F 1/163; G06N 20/00

(57) ABSTRACT

Various implementations disclosed herein include devices, systems, and methods that enable an enrollment process for generating a model used to determine and document a rate and type of liquid consumption by a user. For example, a process may obtain sensor data from a sensor on a wearable device. The sensor data may correspond to attributes related to a first liquid consumption technique used by a user to consume a predetermined amount of liquid. The sensor data may be used to personalize a liquid consumption model to predict characteristics of liquid consumption events. The process may further use the personalized liquid consumption model to identify a first related to a first liquid consumption event involving the user consuming the predetermined amount of liquid with respect to the first liquid consumption technique.

### CROSS REFERENCE TO RELATED APPLICATIONS

This Application claims the benefit of U.S. Provisional Application Serial No. 63/698,689 filed September 25, 2024, which is incorporated herein in its entirety.

### TECHNICAL FIELD

The present disclosure generally relates to systems, methods, and devices that provide an enrollment process for generating a personalized liquid consumption model used to determine and document a rate and type of liquid consumption by a user.

### BACKGROUND

Existing user monitoring techniques may be improved with respect to accuracy and efficiency.

### SUMMARY

Various implementations disclosed herein include devices, systems, and methods that are configured to implement a user enrollment process for generating a model used to determine and document a rate and type of liquid consumption by a user.

In some implementations, a user wearing a wearable device such as a head mounted device (HMD) may initiate an enrollment process and begin consuming (e.g., drinking) predetermined amounts or volumes (e.g., 2 oz, 4 oz, etc.) of a consumable liquid (e.g., water, soda, coffee, tea, any clear liquid, a smoothie, etc.) from a container such as a mug, a travel container, a cup, etc. using multiple, different liquid consumption techniques such as, inter alia, a normal liquid consumption technique, a gulping technique, a sipping technique, using a straw, etc. The wearable device can be configured to record a number of instances of consumption events that it takes for the user to consume the predetermined amount of liquid using a specific liquid consumption technique. That is, based on the amount of time and/or number of instances of consumption events to consume the predetermined amount of liquid, the wearable device can determine a volume of consumption for each instance of the consumption event, e.g., by dividing the predetermined amount of liquid consumed by the number of instances of the consumption event performed to consume the predetermined amount of liquid. For example, it may take 5 sips to consume 5 oz liquid, in which case the device can determine that the user consumes 1 oz of liquid for each sip performed. The wearable device can also record audio (e.g., via a microphone of the wearable device or a separate device) while the user consumes the volume using each consumption technique. The recorded audio can be a sound signature for that consumption technique so that the device can identify which consumption technique is used based on an audio signal. The determined consumption volume of liquid per consumption event and recorded audio signatures may be used to form the personalized liquid consumption model that can subsequently be used to track liquid consumption.

In some implementations, while the user is consuming the liquid, sensor data is obtained. In some implementations, the sensor data may include audio data (e.g., from a microphone) comprising audible sounds (e.g., sipping sounds, gulping sounds, swallowing sounds, etc.) produced by the user during a liquid consumption event.

In some implementations, the sensor data may include inertial measurement unit (IMU) data representing head movements (e.g., a head pose, head movement in an upward or downward direction, etc.) of the user during a liquid consumption event.

In some implementations, the sensor data may include audio accelerometer data produced from body portion movements or vibrations (e.g., from bone and muscle conducting movements) of the user during the liquid consumption event.

In some implementations, the sensor data may include vision sensor data depicting the consumable liquid, the container, environmental context, etc.

In some implementations, the sensor data may include biometric data such as, inter alia, data representing a heartrate of the user.

In some implementations, the sensor data is used to personalize (e.g., train or further train) a liquid consumption model (e.g., a machine learning (ML) model, a rule-based model, etc.) to use subsequent sensor data to predict characteristics of consumption events involving the user. For example, characteristics of consumption events may include, inter alia, a liquid type, an amount of liquid consumed, a liquid consumption technique, a temperature of the liquid, etc.

In some implementations, the personalized liquid consumption model may be subsequently used for liquid consumption tracking, such as intake or caloric tracking, for the user.

In some implementations, the sensor data is used to personalize a rule- based, deterministic model where each sip or gulp results in a certain volume of liquid consumed.

In some implementations, a wearable device has a processor (e.g., one or more processors) that executes instructions stored in a non-transitory computer-readable medium to perform a method. The method performs one or more steps or processes. In some implementations, the wearable device obtains sensor data from the at least one sensor on the wearable device. The sensor data corresponds to attributes related to a first liquid consumption technique used by a user to consume a predetermined amount of liquid. Based on the sensor data a liquid consumption model is personalized to predict characteristics of liquid consumption events. In some implementations, the personalized liquid consumption model may be used to identify a first characteristic of the characteristics. The first characteristic may be related to a first liquid consumption event involving the user consuming the predetermined amount of liquid with respect to the first liquid consumption technique.

In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 illustrates an exemplary electronic device operating in a physical environment, in accordance with some implementations.

FIGS. 2A and 2B illustrate views representing an enrollment process for generating a model used to determine and document a rate and type of liquid consumption by a user, in accordance with some implementations.

FIG. 3 illustrates an example environment for implementing an enrollment process for generating, personalizing, training, or retraining a personalized liquid consumption model used to determine and document a rate and type of liquid consumption by a user, in accordance with some implementations.

FIG. 4 is a flowchart representation of an exemplary method that enables an enrollment process for generating a personalized liquid consumption model used to determine and document a rate and type of liquid consumption by a user, in accordance with some implementations.

FIG. 5 is a block diagram of an electronic device of in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

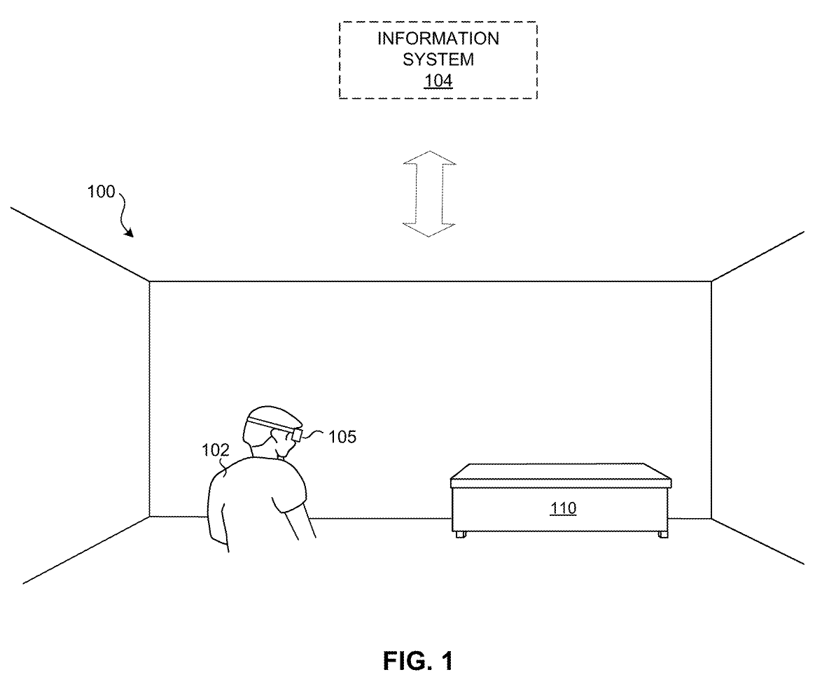

FIG. 1 illustrates an exemplary electronic device 105 operating in a physical environment 100 that may correspond to an extended reality (XR) environment. Additionally, electronic device 105 may be in communication with an information system 104 (e.g., a device control framework or network). In an exemplary implementation, electronic device 105 is sharing information with the information system 104. In the example of FIG. 1, the physical environment 102 is a room that includes physical objects such as a desk 110. The electronic device 105 may include one or more cameras, microphones, depth sensors, IMU sensors, audio accelerometer sensors or other sensors that can be used to capture information about and evaluate the physical environment 100 and the objects within it, as well as information about the user 102 of electronic device 105. The information about the physical environment 100 and/or user 102 may be used to provide visual and audio content, identify objects and actions (of the user), the physical environment 100, and/or to identify the current location of the physical environment 100 and/or the location of the user within the physical environment 100.

In some implementations, views of an extended reality (XR) environment may be provided to one or more participants (e.g., user 102 and/or other participants not shown) via electronic device 105 (e.g., a wearable device such as an HMD). Such an XR environment may include views of a 3D environment that is generated based on camera images and/or depth camera images of the physical environment 100 as well as a representation of user 102 based on camera images and/or depth camera images of the user 102. Such an XR environment may include virtual content that is positioned at 3D locations relative to a 3D coordinate system associated with the XR environment, which may correspond to a 3D coordinate system of the physical environment 100.

In some implementations, a wearable electronic device such as an HMD (e.g., device 105) may be configured to provide instructions to a user wearing the wearable device. The instructions may be used to direct the user to pour a predetermined amount (e.g., 2 oz, 4 oz, 12, oz, 16 oz, etc.) of a specified type of liquid into a container. For example, the user may be directed to add a predetermined amount of water, soda, coffee, tea, a smoothie type substance, etc. to a glass, a cup, a mug, a travel container etc. The wearable electronic device may be configured to instruct the user to use a container having one or more particular characteristics, e.g., transparent, having a particular size, having a particular shape, having a handle, etc.

In some implementations, subsequent to the predetermined amount of the specified type of liquid being added to the container, the user may be instructed (by the wearable device) to consume at least some of the predetermined amount of liquid while performing multiple, different liquid consumption techniques. For example, the user may be instructed to consume the predetermined amount of liquid using a normal liquid consumption technique, a gulping technique, a sipping technique, using a straw, any combination thereof, etc. This may occur in multiple steps, e.g., instructing the user to first consume some of the liquid using a first technique, instructing the user to stop, instructing the user to next consume some of the liquid using a second technique when ready, instructing the user to stop, etc.

In some implementations, sensor data from a sensor(s) on the wearable device may be obtained while the user is consuming the predetermined amount of liquid. The sensor data may correspond to attributes such as, inter alia, sounds, head movements, vibrations, biometric data, etc. of the user while consuming the predetermined amount of liquid with respect to the different liquid consumption techniques. Likewise, the sensor data may additionally depict (e.g., via images) the liquid, a container, environmental context, etc. The sensors may include, audio sensors, IMU sensors, image sensors, audio accelerometer sensors, etc. Timing information may additionally be captured, e.g., via a timing application on the wearable device.

In some implementations, a liquid consumption model may be personalized (e.g., via a training process) to predict characteristics of liquid consumption events based on the sensor data. For example, characteristics of liquid consumption events may include, inter alia, a liquid type (e.g., water), a liquid quantity being consumed, a consumption rate and consumption volume associated with consuming the liquid, a liquid consumption technique, a temperature of the liquid, etc.

In some implementations, the personalized liquid consumption model may be used for liquid consumption tracking for the user. For example, the personalized liquid consumption model may be used for hourly or daily water consumption tracking, calorie tracking, etc.

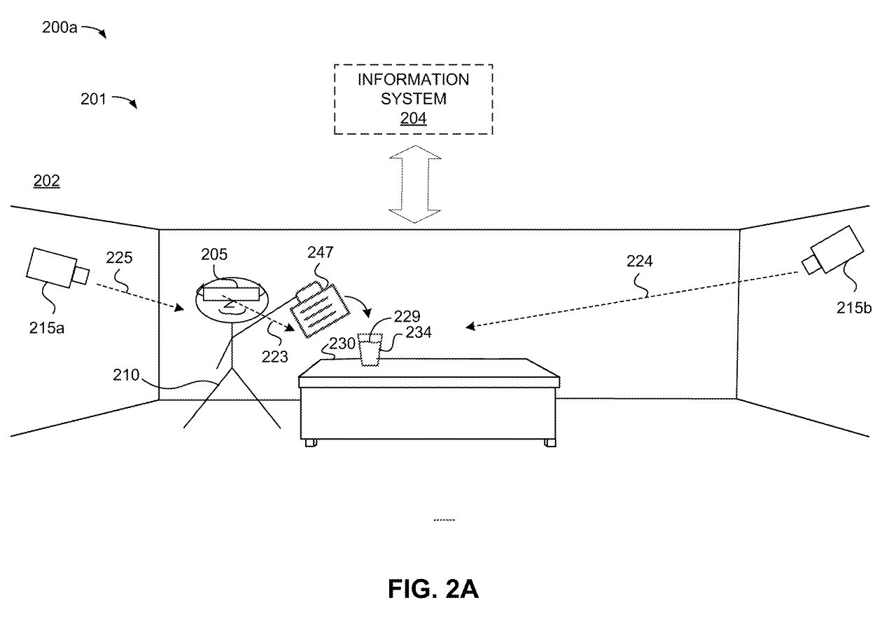

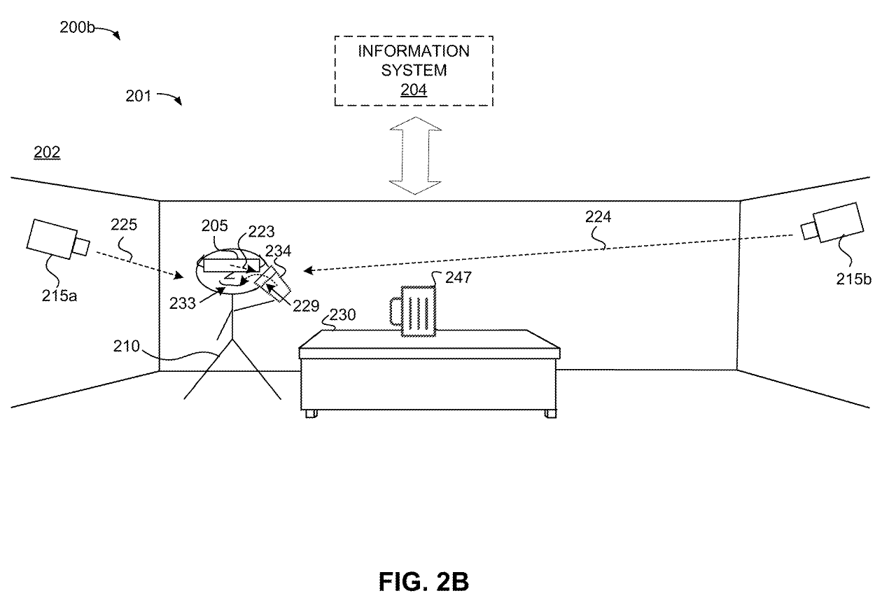

FIGS. 2A and 2B illustrate views 200a and 200b representing an enrollment process for generating a personalized liquid consumption model used to determine and document characteristics (e.g., consumption rate, consumption amount, liquid consumption technique, liquid identification, liquid temperature, etc.) by a user 210, in accordance with some implementations.

FIG. 2A illustrates view 200a representing an example environment 201 comprising exemplary electronic devices 205 (e.g., a wearable device such as an HMD), 215a, and 215b operating in a physical environment 202 during a first time period. Additionally, example environment 201 may include an information system 204 (e.g., a framework, server, controller or network) in communication with one or more of the electronic devices 205, 215a, and 215b. In an exemplary implementation, electronic devices 205, 215a, and 215b are communicating with each other and an intermediary device such as information system 204. In some implementations, electronic devices 205, 215a, and 215b may include HMDs, stand-alone video camera devices, wall-mounted camera devices, wireless headphones that include image and audio sensors, etc. each comprising multiple different sensor types.

In some implementations, physical environment 202 includes a user 210 wearing electronic device 205. In some implementations, electronic device 205 comprises a wearable device (e.g., a head mounted display (HMD) configured to present views of an extended reality (XR) environment (e.g., a 3D scene), which may be based on the physical environment 202, and/or in some implementations include added content such as virtual objects.

In the example of FIG. 2A, the physical environment 202 may be a room that includes physical objects such as a desk 230, a container 247, and a container 234. For example, container 247 may be a pitcher, a bottle, a carafe, a decanter, etc. Likewise, container 234 may be a cup, a glass, a mug, a travel container, etc. In some implementations, the physical environment 202 is a part of an XR environment presented by, for example, electronic device 205.

In some implementations, each electronic device 205, 215a, and 215b may include one or more sensors (e.g., directed towards user 210 via directions 223, 224, and 225) such as, inter alia, cameras, microphones, depth sensors, motion sensors, optical sensors, IMU sensors, image sensors, audio accelerometer sensors, or other sensors, etc. that may be used to capture information about and evaluate the physical environment 202 and/or an XR environment and the objects within it, as well as information about user 210. Each electronic device 205, 215a, and 215b may be configured to detect sounds, head movements, vibrations, biometrics, etc. of the user.

In some implementations, view 200a represents an initialization of an enrollment process for generating a model used to determine and document a rate and type of liquid consumption by a user.

Upon activation, the enrollment process may initially be configured to instruct user 210 (using a wearable device such as electronic device 205) to add a predetermined amount (e.g., 2 oz, 4 oz, etc.) of a specific type of liquid (e.g., water, soda, coffee, smoothie, etc.) to container 234. In response, the user 210 may use container 247 (e.g., comprising the specified type of liquid) to add the predetermined amount of liquid to container 234. For example, the liquid may be added to the container 234 until the liquid reaches a specified level 229 representing the specified amount such as, for example, 12 fluid oz.

In some implementations, during the process for adding the predetermined amount of liquid to the container, sensors of each electronic device 205, 215a, and 215b (e.g., cameras, microphones, depth sensors, motion sensors, optical sensors, IMU sensors, image sensors, audio accelerometer sensors, etc.) may be activated to monitor and track the process. For example, the sensors of each electronic device 205, 215a, and 215b may be configured to monitor an amount, a color, a liquid viscosity, etc. of the liquid to use an input for personalizing a liquid consumption model, rule-based, deterministic model, or a machine learning (ML) model to subsequently predict characteristics of liquid consumption events. Likewise, the sensors of each electronic device 205, 215a, and 215b may be configured to monitor multiple liquid (and solid) types being added to container 234 to determine differing ingredients being added to container 234 use as input for personalizing an ML model to subsequently predict characteristics of liquid consumption events. For example, the sensors of each electronic device 205, 215a, and 215b may detect amounts of coffee, creamer, and sugar being added to container 234 to personalize the liquid consumption model, rule-based, deterministic model, or an ML model to subsequently determine an amount of liquid and associated calories that are being consumed by user 210.

Subsequent to the predetermined amount of the specified liquid type being added to container 234, user 210 may be instructed to consume the predetermined amount of liquid using multiple, different liquid consumption techniques as described with respect to FIG. 2B, infra.

FIG. 2B illustrates view 200b of example environment 201 during a second time period occurring subsequent to the first time period illustrated in view 200b of FIG. 2A, in accordance with some implementations. View 200b illustrates exemplary electronic devices 205, 215a, and 215b operating in physical environment 202 subsequent to a predetermined amount of a specified liquid type being added to container 234 as described with respect to FIG. 2A.

View 200b represents the enrollment process instructing user 210 to consume (e.g., by tipping container 234 towards mouth 233 of user 210) the predetermined amount of liquid (via container 234) using multiple, different liquid consumption techniques associated with consuming the liquid at different speeds. For example, the user may be instructed to consume the predetermined amount by using a normal liquid consumption technique, a gulping technique, a sipping technique, using a straw, etc.

In some implementations, view 200b illustrates that while the user is consuming the liquid, sensor data is obtained from sensors of electronic device 205, 215a, and/or 215b. The sensor data may include audio data (e.g., from a microphone) comprising audible sounds (e.g., sipping sounds, gulping sounds, swallowing sounds, etc.) produced by the user during a liquid consumption event.

In some implementations, the sensor data may include IMU data representing head movements of user 210 during a liquid consumption event. For example, sensor data representing a head pose, head movement in an upward or downward direction, etc. may be obtained from sensors (of any of devices 205, 215a, and/or 215b) such as image sensors, IMU sensors, etc.

In some implementations, the sensor data may include audio accelerometer data produced from body portion movements of the user 210 during the liquid consumption event. For example, the sensor data may include data describing vibrations from bone and muscle conducting movements, etc.

In some implementations, the sensor data may include vision sensor data depicting the consumable liquid and the specified level 229 of the liquid (in container 234), the container 234, environmental context (e.g., associated with physical environment 202), etc.

In some implementations, the sensor data may include biometric data such as data representing a heartrate, a temperature, blood pressure, etc. of the user 210.

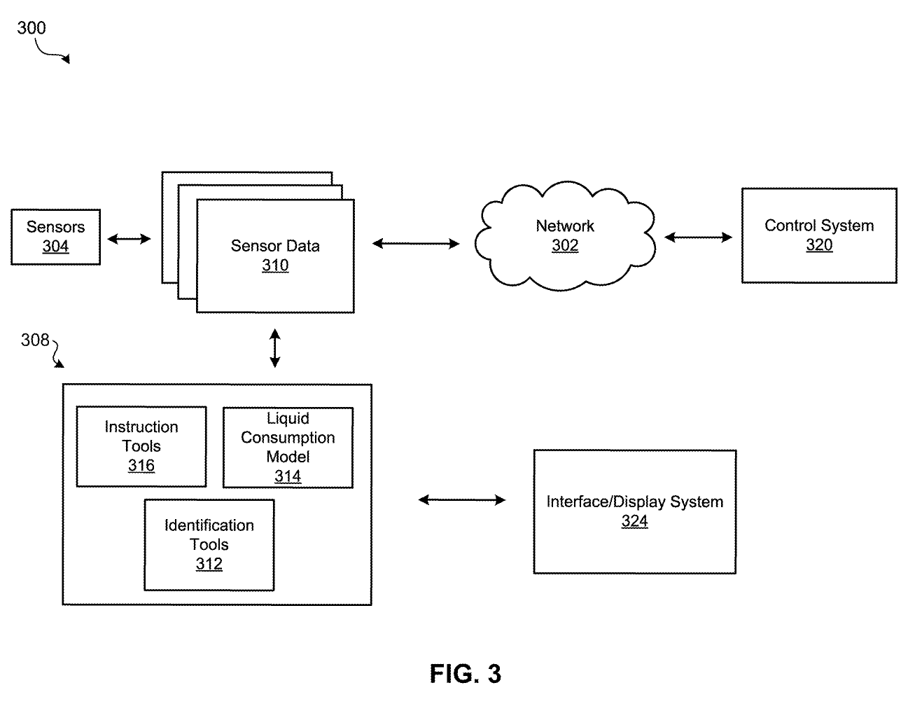

In some implementations, sensor data obtained while the user is consuming the liquid is used to personalize or train an ML model or a rule- based, deterministic model to use subsequent sensor data (e.g., during a usage process) to predict characteristics of consumption events involving the user as further described with respect to FIG. 3, infra. For example, characteristics of consumption events may include, inter alia, a liquid type, an amount of liquid consumed, a liquid consumption technique, a liquid temperature, a mixture of differing liquid and solids (e.g., coffee creamer, and sugar), liquid consumption behavior, etc.

FIG. 3 illustrates an example environment 300 for implementing an enrollment process for generating, personalizing, training, or retraining a liquid consumption model 314 used to determine and document a rate and type of liquid consumption by a user, in accordance with some implementations. The example environment 300 includes sensors 304 (e.g., sensors of electronic devices 205, 215a, and 215b FIGS. 2A and 2B), sensor data 310, tools/software 308, a control system 320 (e.g., information system 104 of FIG. 1), and an interface/display system 324 that, in some implementations, communicates over a data communication network 302, e.g., a local area network (LAN), a wide area network (WAN), the Internet, a mobile network, or a combination thereof.

Tools/software 308 comprise instruction tools 316, identification tools 312, and liquid consumption model 314.

In some implementations, example environment 300 is configured to enable instruction tools 316 to provide instructions (to a user of a wearable device) for directing the user to add a predetermined amount of a specific type of liquid to a container. During the process for adding the predetermined amount of liquid to the container, sensors 304 (of the wearable device or within an environment) may be optionally activated to monitor and track the process and resulting sensor data 310 is obtained. For example, sensors 304 may be configured to monitor an amount, a color, a liquid viscosity, etc. of the liquid to use an input for personalizing liquid consumption model 314 and subsequently, user liquid consumption (e.g., for predicting characteristics of liquid consumption events used for training) may be monitored to additionally use as input for personalizing liquid consumption model 314 such as an ML model, a rule- based, deterministic model , etc.

In some implementation, sensors 304 are configured to monitor multiple liquid (and solid) types being added to the container to determine differing ingredients being added to container use as input for personalizing liquid consumption model 314 to subsequently predict characteristics of liquid consumption events.

In some implementations, subsequent to the predetermined amount of the specified liquid type being added to the container, the user may be instructed to consume the predetermined amount of liquid using multiple, different liquid consumption techniques, for example, associated with consuming the liquid with respect to different intervals, amounts, and/or different speeds. For example, the user may be instructed to consume the predetermined amount of liquid via a normal liquid consumption technique, a gulping technique (e.g., a plurality of quick consumptions of the liquid until the predetermined amount of liquid has been consumed), a sipping technique, using a straw, etc.

During consumption of the liquid using the multiple, different liquid consumption techniques, sensor data 310 is obtained from sensors 304. In this instance, sensor data 304 may include audio data (e.g., from a microphone) comprising audible sounds (e.g., sipping sounds, gulping sounds, swallowing sounds, etc.) produced by the user during liquid consumption, IMU data representing head movements of the user during liquid consumption, audio accelerometer data produced from vibrations associated with bone and muscle conducting movements, vision sensor data depicting the consumable liquid and a level of the liquid with respect to its container, biometric data such as data representing a heartrate, etc.

In some implementations, a user wearing a device consumes a predetermined amount or volume (e.g., 2 oz, 4 oz, etc.) of a specific type of consumable liquid such as water, soda, coffee, tea, any clear liquid, a smoothie, etc.) from a container such as a mug, a travel container, a cup, etc. using multiple, different liquid consumption techniques such as, inter alia, a normal liquid consumption technique, a gulping technique, a sipping technique, using a straw, etc.

In response to the user consuming the predetermined amount of liquid, the device is records audio (e.g., via sensors such as a microphone of the wearable device) of sounds associated with the user consuming the predetermined amount of liquid using the multiple, different liquid consumption techniques. Likewise, the wearable device records an amount of time that it takes for the user to consume the predetermined amount of liquid using different liquid consumption techniques, etc. Accordingly, based on the recorded data, the device may determine a volume of liquid in a container so that the wearable device may determine an amount of time that it takes for the volume of liquid to be consumed. For example, it may take 3 sips, 2 gulps, or 6 sips from a straw etc. to consume 6 oz liquid. This information may be used by the device to determine a volume that is consumed for each of the different liquid consumption techniques. The volume of liquid that is consumed may be used to track liquid consumption during a subsequent time.

The sensor data obtained while the user is consuming the liquid is used to personalize or train liquid consumption model 314 to predict characteristics of consumption events involving the user.

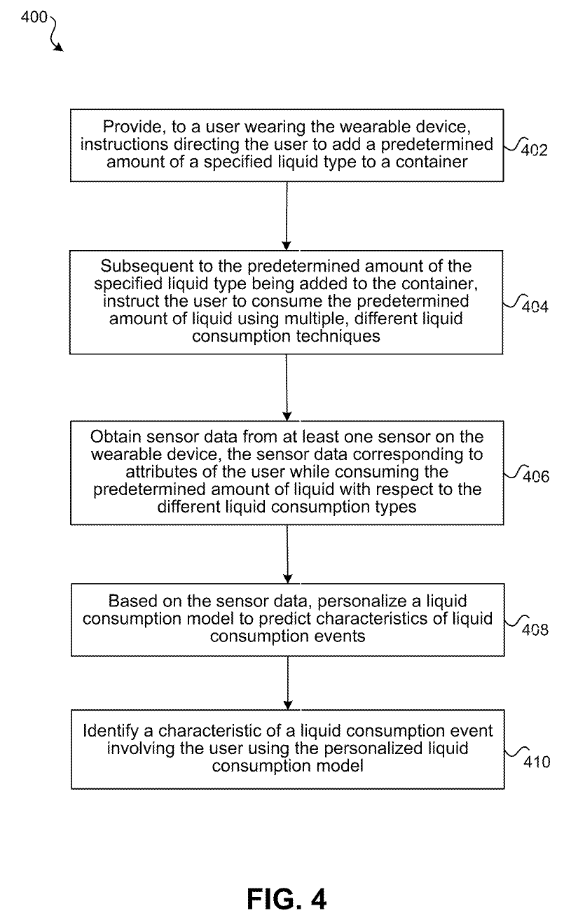

FIG. 4 is a flowchart representation of an exemplary method 400 that enables an enrollment process for generating a liquid consumption model used to determine and document a rate and type of liquid consumption by a user, in accordance with some implementations. In some implementations, the method 400 is performed by a device(s), such as a tablet device, mobile device, desktop, laptop, HMD, server device, information system, wireless headphones with image and audio sensors, etc. In some implementations, the device has a screen for displaying images and/or a screen for viewing stereoscopic images such as a head-mounted display (HMD such as e.g., device 105 of FIG. 1). In some implementations, the method 400 is performed by processing logic, including hardware, firmware, software, or a combination thereof. In some implementations, the method 400 is performed by a processor executing code stored in a non-transitory computer-readable medium (e.g., a memory). Each of the blocks in the method 400 may be enabled and executed in any order.

At block 402, the method 400 provides, to a user wearing a wearable device such as an HMD, instructions directing the user to add a predetermined amount of a specified liquid type to a container. For example, a predetermined amount such as 2 oz, 4 oz, 12 oz, etc. of a specified liquid type such as water, soda, coffee, smoothie, etc. may be added to a container (e.g., container 234 illustrated in FIGS. 2A and 2B) such as a glass, a cup, a mug etc. as described with respect to FIGS. 2A and 2B. Input may be received from the user identifying characteristics of the liquid, e.g., its type, viscosity, carbonated versus non-carbonated, hot versus cold, with ice cubes versus without ice cubes, etc. Input may be received from the user identifying characteristics of the liquid container, e.g., its shape, size, whether it has a handle or not, whether it has a lid or not, whether it has a straw or not, whether it has volume markings that enable the user to see current fill level, etc. Information about the liquid and/or the liquid container may be known from user instructions, user input provided values, and/or determined via one or more device sensors. Such information may be stored and used in training a machine learning model to track consumption characteristics, e.g., providing ground truth information.

At block 404, subsequent to the predetermined amount of the specified liquid type being added to the container, the method 400 instructs the user to consume the predetermined amount of liquid using multiple, different liquid consumption techniques such as, inter alia, a normal liquid consumption technique, a gulping technique, a sipping technique, using a straw, etc. as described with respect to FIGS. 2A and 2B. Input may be received from the user identifying characteristics of the liquid after consumption, e.g., identifying whether any liquid remains, how much liquid remains in the container, if any, whether the consumption technique was used to consume the liquid, etc. Such information may be stored and used in training a machine learning model to track consumption characteristics, e.g., providing ground truth information.

At block 406, the method 400 obtains sensor data from at least one sensor on the wearable device. In some implementations, the sensor data may correspond to attributes of the user while consuming the predetermined amount of liquid with respect to the different liquid consumption techniques as described with respect to FIGS. 2A and 2B. Such sensor data may be stored and used in training a liquid consumption model or a machine learning model to track consumption characteristics, e.g., sample input information.

Alternatively, the sensor data may be used to personalize a rule-based or heuristic based model representing each of the different liquid consumption techniques (e.g., sip or gulp) resulting in a specified volume of liquid being consumed.

In some implementations, the attributes may include audible sounds such as sipping sounds, gulping sounds, swallowing sounds, etc. that are produced by the user while consuming the predetermined amount of liquid as described with respect to FIG. 3.

In some implementations, the attributes may include head movements such as a head pose, head movement in an upward or downward direction, etc. of the user while consuming the predetermined amount of liquid as described with respect to FIG. 3.

In some implementations, the attributes may include vibrations produced from body portion movements of the user while consuming the predetermined amount of liquid. For example, body portion movements of a user 210 may include vibrations from bone and muscle conducting movements as described with respect to FIGS. 2A, 2B and 3.

In some implementations, the attributes may include biometric attributes of the user while consuming the predetermined amount of liquid. For example, biometric data representing a heartrate, a temperature, blood pressure, etc. of a user 210 as described with respect to FIGS. 2A and 2B.

In some implementations, sensor data may include audio data from a microphone. For example, sensor data 304 including audio data such as audio from a microphone as described with respect to FIG. 3.

In some implementations, sensor data may include IMU data. For example, sensor data 304 including IMU data representing head movements of a user during the liquid consumption as described with respect to FIG. 3.

In some implementations, sensor data may include audio accelerometer data. For example, sensor data 304 including audio accelerometer data produced from vibrations associated with bone and muscle conducting movements as described with respect to FIG. 3.

In some implementations, sensor data may include vision sensor data depicting the predetermined amount of liquid, the container, and/or an environmental context of a location of the user wearing the wearable device as described with respect to FIG. 3.

At block 408, the method 400 personalizes a machine learning (ML) model, a rule-based, a heuristic based model, etc. (e.g., liquid consumption model 314 as described with respect to FIG. 3) to predict characteristics of liquid consumption events based on the sensor data. In one example, a liquid consumption model is trained to use sensor data corresponding to user activity (e.g., body movements, heart rate, sounds produced by the body, etc.) to predict characteristics of liquid consumption that are compared against characteristics of the liquid consumption known from the ground truth data to adjust or otherwise train the liquid consumption model, e.g., adjusting weights of a neural network. In some implementations, a liquid consumption model for liquid consumption is previously trained for general user liquid consumption liquid consumption s and this liquid consumption model is further trained using user-specific information, e.g., during an enrollment process, to be personalized for the user and thus better able to accurately and efficiently predict the user’s liquid consumption characteristics than the generic, un-personalized liquid consumption model.

In some implementations, the method 400 uses rule-based, deterministic models to predict characteristics of liquid consumption events based on the sensor data.

In some implementations, characteristics of liquid consumption events may include a type of liquid being consumed. For example, water, soda, coffee, smoothie, etc. as described with respect to FIGS. 2A and 2B.

In some implementations, characteristics of liquid consumption events may include a quantity of the liquid being consumed. For example, 2oz, 4oz, etc. as described with respect to FIGS. 2A and 2B.

In some implementations, characteristics of liquid consumption events may include a temperature of the liquid being consumed. For example, 42 degrees for cold liquids, 100 degrees for hot liquids, etc. as described with respect to FIGS. 2A and 2B.

In some implementations, characteristics of liquid consumption events may include a consumption rate and consumption volume of the liquid being consumed as described with respect to FIG. 1.

At block 410, the method 400 identifies (e.g., via identification tools 312 as described with respect to FIG. 3) a characteristic of a liquid consumption event involving the user using the personalized ML model.

In some implementations, identifying the characteristic of the liquid consumption event may be performed in real time as described with respect to FIG. 3.

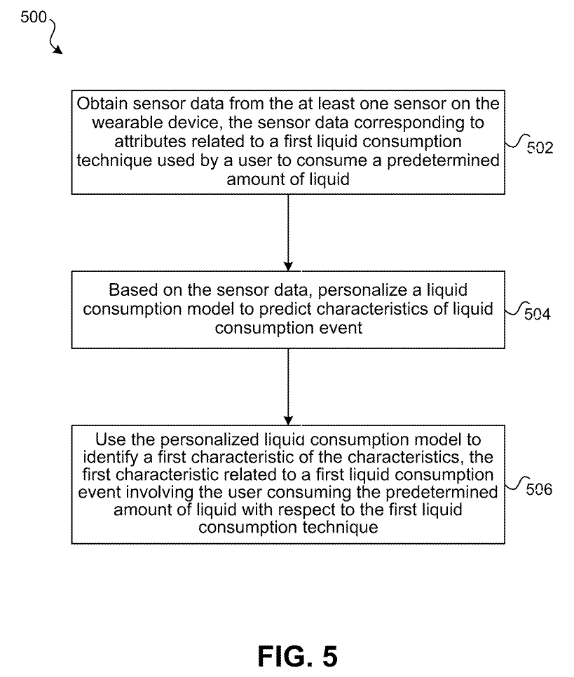

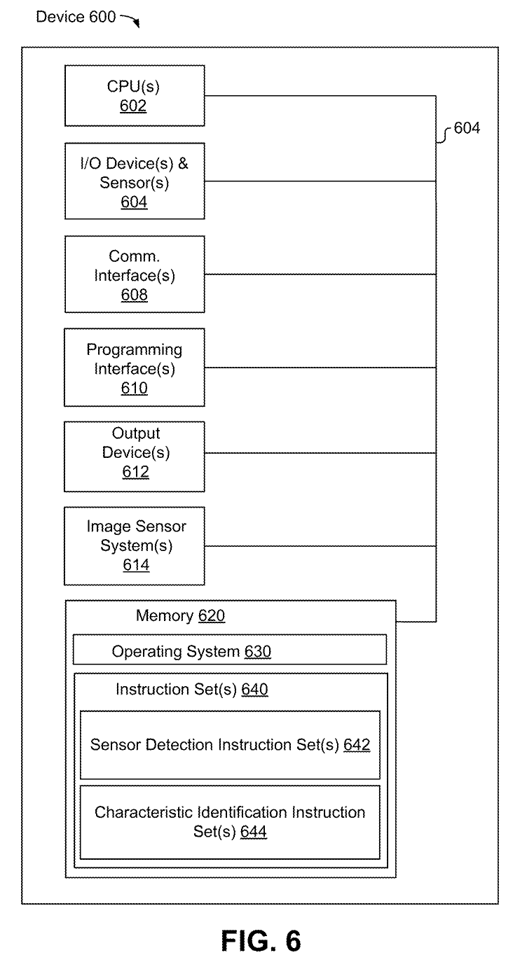

FIG. 5 is a flowchart representation of an exemplary method 500 that enables an enrollment process for generating a liquid consumption model used to determine and document a rate and type of liquid consumption technique by a user, in accordance with some implementations. In some implementations, the method 500 is performed by a device(s), such as a tablet device, mobile device, desktop, laptop, HMD, server device, information system, wireless headphones with image and audio sensors, etc. In some implementations, the device has a screen for displaying images and/or a screen for viewing stereoscopic images such as a head-mounted display (HMD such as e.g., device 105 of FIG. 1). In some implementations, the method 500 is performed by processing logic, including hardware, firmware, software, or a combination thereof. In some implementations, the method 500 is performed by a processor executing code stored in a non-transitory computer-readable medium (e.g., a memory). Each of the blocks in the method 400 may be enabled and executed in any order.

At block 502, the method 500 obtains sensor data from at least one sensor on a wearable device. The sensor data may correspond to attributes (e.g., sounds, head movements, vibrations, etc. from audio sensors such as microphones, IMU sensors, etc.) related to a first liquid consumption technique used by a user to consume a predetermined amount of liquid. Attributes may include, inter alia, sounds, head movements, vibrations, etc. obtained from, inter alia, cameras, microphones, depth sensors, motion sensors, optical sensors, IMU sensors, image sensors, audio accelerometer sensors, or other sensors, etc. as described with respect to FIG. 2. A liquid consumption technique may include, inter alia, a normal liquid consumption technique, a gulping technique, a sipping technique, using a straw, etc. as described with respect to FIG. 2.

At block 504 based on the sensor data, the method 500 personalizes a liquid consumption model (e.g., liquid consumption model 314 in FIG. 3) to predict characteristics of liquid consumption events.

In some implementations, the characteristics of liquid consumption events may include, a consumption rate of the liquid being consumed, a consumption volume of the liquid being consumed, a type of the liquid being consumed, a temperature of liquid being consumed, a quantity of the liquid being consumed, etc.

At block 506, the method 500 uses the personalized liquid consumption model to identify a first characteristic of the characteristics. The first characteristic is related to a first liquid consumption event (e.g., a consumption rate and/or a consumption volume) involving the user consuming the predetermined amount of liquid with respect to the first liquid consumption technique. The method 500 may be repeated for all liquid consumption techniques.

In some implementations, the method 500 may implement an example enrollment process (e.g., session) as follows:

The enrollment process may be initiated actively (e.g., the wearable device prompts user to begin enrollment) or passively (e.g., using computer vision to detect a specific container for enrollment that illustrates an amount of volume in the container).

Subsequently, while the user is consuming the liquid using the liquid consumption technique, audio and IMU data associated with sounds and movements occurring is obtained and a volume of the liquid consumed during each instance may be calculated by dividing the predetermined volume by a number of instances of the drinking technique after the liquid has been consumed.

Subsequently (during the enrollment session), the user may refill the container with a same amount of the specified type of liquid and consume (during a second instance) the liquid using a different liquid consumption technique (e.g., gulps) to determine the volume of the liquid being consumed during each instance of the different liquid consumption technique (e.g., by dividing the predetermined volume by a number of instances of the liquid consumption techniques). For example, during a first liquid consumption instance, the user may require 4 sips to consume 4 oz of liquid (e.g., 1 oz per sip) and during a second instance during the enrollment session, the user may require 2 gulps to consume 4 oz of liquid (e.g., 2 oz per gulp), etc. The aforementioned process may be repeated for all liquid consumption techniques (e.g., normal drinking, drinking with a straw, etc.).

FIG. 6 is a block diagram of an example device 600. Device 600 illustrates an exemplary device configuration for electronic device 105 of FIG. 1. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the device 600 includes one or more processing units 602 (e.g., microprocessors, ASICs, FPGAs, GPUs, CPUs, processing cores, and/or the like), one or more input/output (I/O) devices and sensors 604, one or more communication interfaces 608 (e.g., USB, FIREWIRE, THUNDERBOLT, IEEE 802.3x, IEEE 802.11x, IEEE 802.14x, GSM, CDMA, TDMA, GPS, IR, BLUETOOTH, ZIGBEE, SPI, I2C, and/or the like type interface), one or more programming (e.g., I/O) interfaces 610, output devices (e.g., one or more displays) 612, one or more interior and/or exterior facing image sensor systems 614, a memory 620, and one or more communication buses 604 for interconnecting these and various other components.

In some implementations, the one or more communication buses 604 include circuitry that interconnects and controls communications between system components. In some implementations, the one or more I/O devices and sensors 606 include at least one of an inertial measurement unit (IMU), an accelerometer, a magnetometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), one or more cameras (e.g., inward facing cameras and outward facing cameras of an HMD), one or more infrared sensors, one or more heat map sensors, and/or the like.

In some implementations, the one or more displays 612 are configured to present a view of a physical environment, a graphical environment, an extended reality environment, etc. to the user. In some implementations, the one or more displays 612 are configured to present content (determined based on a determined user/object location of the user within the physical environment) to the user. In some implementations, the one or more displays 612 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electromechanical system (MEMS), and/or the like display types. In some implementations, the one or more displays 612 correspond to diffractive, reflective, polarized, holographic, etc. waveguide displays. In one example, the device 600 includes a single display. In another example, the device 600 includes a display for each eye of the user.

In some implementations, the one or more image sensor systems 614 are configured to obtain image data that corresponds to at least a portion of the physical environment 100. For example, the one or more image sensor systems 614 include one or more RGB cameras (e.g., with a complimentary metal-oxide-semiconductor (CMOS) image sensor or a charge-coupled device (CCD) image sensor), monochrome cameras, IR cameras, depth cameras, event-based cameras, and/or the like. In various implementations, the one or more image sensor systems 614 further include illumination sources that emit light, such as a flash. In various implementations, the one or more image sensor systems 614 further include an on-camera image signal processor (ISP) configured to execute a plurality of processing operations on the image data.

In some implementations, sensor data may be obtained by device(s) (e.g., devices 105 and 110 of FIG. 1) during a scan of a room of a physical environment. The sensor data may include a 3D point cloud and a sequence of 2D images corresponding to captured views of the room during the scan of the room. In some implementations, the sensor data includes image data (e.g., from an RGB camera), depth data (e.g., a depth image from a depth camera), ambient light sensor data (e.g., from an ambient light sensor), and/or motion data from one or more motion sensors (e.g., accelerometers, gyroscopes, IMU, etc.). In some implementations, the sensor data includes visual inertial odometry (VIO) data determined based on image data. The 3D point cloud may provide semantic information about one or more elements of the room. The 3D point cloud may provide information about the positions and appearance of surface portions within the physical environment. In some implementations, the 3D point cloud is obtained over time, e.g., during a scan of the room, and the 3D point cloud may be updated, and updated versions of the 3D point cloud obtained over time. For example, a 3D representation may be obtained (and analyzed/processed) as it is updated/adjusted over time (e.g., as the user scans a room).

In some implementations, sensor data may be positioning information, some implementations include a VIO to determine equivalent odometry information using sequential camera images (e.g., light intensity image data) and motion data (e.g., acquired from the IMU/motion sensor) to estimate the distance traveled. Alternatively, some implementations of the present disclosure may include a simultaneous localization and mapping (SLAM) system (e.g., position sensors). The SLAM system may include a multidimensional (e.g., 3D) laser scanning and range-measuring system that is GPS independent and that provides real-time simultaneous location and mapping. The SLAM system may generate and manage data for a very accurate point cloud that results from reflections of laser scanning from objects in an environment. Movements of any of the points in the point cloud are accurately tracked over time, so that the SLAM system can maintain precise understanding of its location and orientation as it travels through an environment, using the points in the point cloud as reference points for the location.

In some implementations, the device 600 includes an eye tracking system for detecting eye position and eye movements (e.g., eye gaze detection). For example, an eye tracking system may include one or more infrared (IR) light-emitting diodes (LEDs), an eye tracking camera (e.g., near-IR (NIR) camera), and an illumination source (e.g., an NIR light source) that emits light (e.g., NIR light) towards the eyes of the user. Moreover, the illumination source of the device 600 may emit NIR light to illuminate the eyes of the user and the NIR camera may capture images of the eyes of the user. In some implementations, images captured by the eye tracking system may be analyzed to detect position and movements of the eyes of the user, or to detect other information about the eyes such as pupil dilation or pupil diameter. Moreover, the point of gaze estimated from the eye tracking images may enable gaze-based interaction with content shown on the near-eye display of the device 600.

The memory 620 includes high-speed random-access memory, such as DRAM, SRAM, DDR RAM, or other random-access solid-state memory devices. In some implementations, the memory 620 includes non-volatile memory, such as one or more magnetic disk storage devices, optical disk storage devices, flash memory devices, or other non-volatile solid-state storage devices. The memory 620 optionally includes one or more storage devices remotely located from the one or more processing units 602. The memory 620 includes a non-transitory computer readable storage medium.

In some implementations, the memory 620 or the non-transitory computer readable storage medium of the memory 620 stores an optional operating system 630 and one or more instruction set(s) 640. The operating system 630 includes procedures for handling various basic system services and for performing hardware dependent tasks. In some implementations, the instruction set(s) 640 include executable software defined by binary information stored in the form of electrical charge. In some implementations, the instruction set(s) 640 are software that is executable by the one or more processing units 602 to carry out one or more of the techniques described herein.

The instruction set(s) 640 includes a sensor detection instruction set 642 and a characteristic identification instruction set 644. The instruction set(s) 640 may be embodied as a single software executable or multiple software executables.

The sensor detection instruction set 642 is configured with instructions executable by a processor to obtain sensor data from a sensor(s) on a wearable device. The sensor data may correspond to attributes (e.g., sounds, head movements, vibrations, etc.) of a user while consuming a predetermined amount of liquid with respect to different liquid consumption techniques.

The characteristic identification instruction set 644 is configured with instructions executable by a processor to identify a characteristic of a liquid consumption event involving user using a personalized ML model.

Although the instruction set(s) 640 are shown as residing on a single device, it should be understood that in other implementations, any combination of the elements may be located in separate computing devices. Moreover, FIG. 6 is intended more as functional description of the various features which are present in a particular implementation as opposed to a structural schematic of the implementations described herein. As recognized by those of ordinary skill in the art, items shown separately could be combined and some items could be separated. The actual number of instructions sets and how features are allocated among them may vary from one implementation to another and may depend in part on the particular combination of hardware, software, and/or firmware chosen for a particular implementation.

Those of ordinary skill in the art will appreciate that well-known systems, methods, components, devices, and circuits have not been described in exhaustive detail so as not to obscure more pertinent aspects of the example implementations described herein. Moreover, other effective aspects and/or variants do not include all of the specific details described herein. Thus, several details are described in order to provide a thorough understanding of the example aspects as shown in the drawings. Moreover, the drawings merely show some example embodiments of the present disclosure and are therefore not to be considered limiting.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, e.g., one or more models of computer program instructions, encoded on computer storage medium for execution by, or to control the operation of, data processing apparatus. Alternatively, or additionally, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures. Unless specifically stated otherwise, it is appreciated that throughout this specification discussions utilizing the terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Implementations of the methods disclosed herein may be performed in the operation of such computing devices. The order of the blocks presented in the examples above can be varied for example, blocks can be re-ordered, combined, and/or broken into sub-blocks. Certain blocks or processes can be performed in parallel. The operations described in this specification can be implemented as operations performed by a data processing apparatus on data stored on one or more computer-readable storage devices or received from other sources.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

What is claimed is:

1. A method comprising:
at a processor of a wearable device:
obtaining sensor data from at least one sensor on the wearable device, the sensor data corresponding to attributes related to a first liquid consumption technique used by a user to consume a predetermined amount of liquid;
based on the sensor data, personalizing a liquid consumption model to predict characteristics of liquid consumption events; and
using the personalized liquid consumption model to identify a first characteristic of the characteristics, the first characteristic related to a first liquid consumption event involving the user consuming the predetermined amount of liquid with respect to the first liquid consumption technique.

2. The method of claim 1, wherein the attributes are further related to a second liquid consumption technique differing from the first liquid consumption technique used by the user to consume the predetermined amount of liquid, and wherein the method further comprises:
using the personalized liquid consumption model to identify a second characteristic (e.g., a consumption volume) of the characteristics, the second characteristic related to a second liquid consumption event involving the user consuming the predetermined amount of liquid with respect to the second liquid consumption technique.

3. The method of claim 1, wherein the characteristics of liquid consumption events comprise a consumption rate of the liquid being consumed.

4. The method of claim 1, wherein the characteristics of liquid consumption events comprise a consumption volume of the liquid being consumed.

5. The method of claim 1, wherein the characteristics of liquid consumption events comprise a type of the liquid being consumed.

6. The method of claim 1, wherein the characteristics of liquid consumption events comprise a quantity of the liquid being consumed.

7. The method of claim 1, wherein the attributes comprise audible sounds produced by the user while consuming the predetermined amount of liquid.

8. The method of claim 1, wherein the attributes comprise head movements of the user while consuming the predetermined amount of liquid.

9. The method of claim 1, wherein the attributes comprise vibrations produced from body portion movements of the user while consuming the predetermined amount of liquid.

10. The method of claim 1, wherein the attributes comprise biometric attributes of the user while consuming the predetermined amount of liquid.

11. The method of claim 1, wherein the sensor data comprises audio data from a microphone.

12. The method of claim 1, wherein the sensor data comprises IMU data.

13. The method of claim 1, wherein the sensor data comprises audio accelerometer data.

14. The method of claim 1, wherein the sensor data comprises vision sensor data depicting the predetermined amount of liquid, the container, and an environmental context of a location of the user wearing the wearable device.

15. The method of claim 1, wherein the different liquid consumption techniques comprise normal liquid consumption techniques, gulping liquid consumption techniques, sipping liquid consumption techniques, or liquid consumption techniques involving use of a straw.

16. The method of claim 1, wherein said identifying the characteristic of the liquid consumption event is performed in real time.

17. A wearable device comprising:
a non-transitory computer-readable storage medium;
at least one sensor; and
one or more processors coupled to the non-transitory computer-readable storage medium, wherein the non-transitory computer-readable storage medium comprises program instructions that, when executed on the one or more processors, cause the wearable device to perform operations comprising:
obtaining sensor data from the at least one sensor on the wearable device, the sensor data corresponding to attributes related to a first liquid consumption technique used by a user to consume a predetermined amount of liquid;
based on the sensor data, personalizing a liquid consumption model to predict characteristics of liquid consumption events; and
using the personalized liquid consumption model to identify a first characteristic of the characteristics, the first characteristic related to a first liquid consumption event involving the user consuming the predetermined amount of liquid with respect to the first liquid consumption technique.

18. The wearable device of claim 17, wherein the characteristics of liquid consumption events comprise a consumption rate of the liquid being consumed.

19. The method of claim 17, wherein the characteristics of liquid consumption events comprise a consumption volume of the liquid being consumed.

20. A non-transitory computer-readable storage medium, storing program instructions executable by one or more processors to perform operations comprising:
at a wearable device having a processor and at least one sensor:
obtaining sensor data from the at least one sensor on the wearable device, the sensor data corresponding to attributes related to a first liquid consumption technique used by a user to consume a predetermined amount of liquid;
based on the sensor data, personalizing a liquid consumption model to predict characteristics of liquid consumption events; and
using the personalized liquid consumption model to identify a first characteristic of the characteristics, the first characteristic related to a first liquid consumption event involving the user consuming the predetermined amount of liquid with respect to the first liquid consumption technique.
